(19) United States
(12) Patent Application Publication
(10) Pub. No.: US 2004/0000095 A1
(43) Pub. Date: Jan. 1, 2004

(54) Window securement means

(76) Inventor: Robin Smith, New Orleans, LA (US)

Correspondence Address: MELVIN K. SILVERMAN & ASSOC.,P.C., Suite 500, 500 West Cypress Creek Road, Fort Lauderdale, FL, 33309, US

(21) Appl. No.: 10/602,211

(22) Filed: Jun. 24, 2003

Related U.S. Application Data
(60) Provisional application No. 60/390,541, filed on Jun. 24, 2002.

(51) Int. Cl. E05F 1/00

(52) U.S. Cl. 49/449

(57) ABSTRACT

A dual function window security means for a double hung casement window includes an elongated hollow tube having spaced apart tube apertures along the elongated hollow tube; a hollow piston means having spaced apart piston apertures along the piston means, which is telescopically connected to the elongated hollow tube; a locking mechanism to interlock the elongated hollow tube and the piston means through the apertures; and an orientation sensor positioned inside the hollow piston means near one end. When in use, one positions the window to a desired opening, and places the window security means between the window panel edge and the window sash. Using this device, the window can be opened and locked at a desired level, which prevents an unauthorized entrant through the window from outside. If the window security means is tilted from a predetermined orientation, the orientation sensor activates and generates alarming signals.

### REFERENCE TO RELATED APPLICATION

This application claims priority to co-pending Provisional Application Serial No. 60/390,541 filed Jun. 24, 2002, which is herein incorporated by reference in its entirety.

### BACKGROUND OF THE INVENTION

The instant invention relates to an improved window security means for double hung casement windows of a type which open and close by the sliding of upper and/or lower portions thereof within parallel tracks within vertical sashes thereof.

Various types of security means which, in effect, are window locks are well known in the art as, for example, are reflected in U.S. Pat. Nos. 1,360,628; 1,601,524; 1,811,681; 2,837,905; 2,912,268; 3,136,290; 3,512,821; 3,606,421; 3,837,191; and 4,152,018 to Cantrell. Each of these systems, as well as others, have, as their end result, a securement of the window in a closed position. Prior art which provides a security function that does not maintain the window in a completely closed or locked position is reflected in U.S. Pat. No. 4,653,226 (1987) to Woodrow. However, systems such as Woodrow provide only for a particular extent of opening of a window and/or require a modification of the internal structure within the window sash itself.

The instant invention responds to these limitations in the prior art by a window security means in which the extent that one or the other of the windows of a double hung casement type may be secured in a partially open position that is defined by the user thereof, that is, a window that is neither locked shut nor secured in an open position to one particular defined dimension.

Such capability is advantageous in that it enables a user thereof to exercise control with respect to the extent that the window is opened, this for purposes of ventilation or otherwise. Also, the present system provides equal protection with regard. to security from external threats, e.g., burglars, or from security issues of internal safety, that is, a child or pet opening a window of such a double hung casement type and thereby falling a substantial distance to the pavement. In such context, the degree to which one may wish to secure a window of such a system in an open position can be a function of many variables inclusive of the age of a child, the type of pets at home, the crime rate in a particular neighborhood, the height above the ground that the particular dwelling is located, as well as outside weather that may occur during a period of absence of the owner or tenant from a dwelling. For example, if rain or the like is anticipated, one may wish to leave the window open to a small extent such as one inch; however, if weather conditions are not an issue, one may wish to secure the window open to a larger degree, for example, three or four inches so that more ventilation may occur.

The instant invention thereby responds to the long felt need in the art for a window security means, or article, capable of providing such variations in the extent of opening of a window, of a double hung casement window type, that does not require attachment of the article to the window and which does not require any alteration of the internal mechanics of the sashes of the window.

On the other hand, various window alarm systems, particularly motion sensor based electronic systems, are known in the art. However, these systems do not have the function of locking a window at a desired opening. Therefore, it is desirable to have a dual function window security device which enables the user to lock a window at a desired extent of opening, and also functions as a window alarm device.

### SUMMARY OF THE INVENTION

In one embodiment, the present invention provides a window security means for a double hung casement window, which includes a tube having a plurality of longitudinal apertures and, telescoped therewithin, a complementally slidable rod or piston also having a plurality of longitudinal apertures therein. Upon telescoping of the respective tubular and rod elements of the security means, apertures of the. respective elements are aligned such that a peg-like element may be placed through aligned pairs of apertures to thereby preclude relative movement between the elements of the security means and to effectively establish the length thereof. The positioning of the respective tube and rod elements of the present invention is thereby effectuated while the security means is positioned vertically between horizontal surfaces of a horizontal jamb of the double hung casement system and the window to remain open, this to the extent desired by the user thereof. A block or the like of selected size may be used to define the extent of the opening. Resilient elastomeric or rubber-like feet are provided at respectively opposite ends of the respective elements of the telescoping structure to provide stability relative to the horizontal surfaces to which it is secured and to reduce the possibility of damage to the windows and other surfaces.

In a further embodiment, the present invention provides a dual function window security means for a double hung casement window. The dual function window security means includes an elongated hollow tube having spaced apart tube apertures along the elongated hollow tube; a hollow piston means having spaced apart piston apertures along the piston means, which is telescopically connected to the elongated hollow tube; a locking mechanism to interlock the elongated hollow tube and the piston means through the apertures; and an orientation sensor positioned inside the hollow piston means near one end. When in use, one positions the window to a desired opening, and places the window security means between the window panel edge and the window sash. Using this device, the window can be opened and locked at a desired level, which prevents an unauthorized entrant through the window from outside. If the window security means is tilted from a predetermined orientation, the orientation sensor activates and generates alarming signals.

It is accordingly an object of the present invention to provide a window security means or article to effectively lock at least one window of a double hung casement system at a selectable extent of opening thereof.

It is a further object of the present invention to provide a dual function window security means which conveniently locks the window to a desired extent of opening, and functions as a window alarm to prevent unauthorized entrant.

It is another object to provide a means or article of the above type that does not require permanent attachment to the window or alteration of the mechanics of a window movement mechanism within vertical sashes of the casement system.

It is a yet further object of the invention to provide a means of the above type that may be provided in both a manual and pneumatically operated embodiment.

The above and yet other objects and advantages of the invention will become apparent from the hereinafter set forth Brief Description of the Drawings and Detailed Description of the Invention.

### BRIEF DESCRIPTION OF THE DRAWINGS

FIG. 1 is a perspective view of a double hung casement window system which has been provided with the inventive system to enable one window to be closed while the other window is held open to a defined extent.

FIG. 2 is a front elevational view of the inventive security means.

FIG. 3 is a side view of the means for securing the cylindrical and rod portions of the invention to each other.

FIG. 4 is a further embodiment of the invention using a pneumatic pump to adjust the axial length of the inventive security means.

FIG. 5 is a partially exploded view of a dual function window security means of one embodiment of the present invention.

FIGS. 6A and 6B are a side sectional view and a top sectional view of a dual function window security means of one embodiment of the present invention, respectively.

FIGS. 7A, 7B and 7C are a first side view, a top view, and a second side view along the longitudinal axis of the hollow piston means, respectively, of the orientation blocking mechanism of the dual function window security means of FIG. 6.

FIG. 8 is a partial side sectional view of the dual function window security means of FIG. 6 with a reset key.

FIG. 9 shows a side view and a top view of an internal mounting support of the dual function window security means of FIG. 6.

### DETAILED DESCRIPTION OF THE INVENTION

With reference to the perspective view of FIG. 1, a double hung frame window 10 may be seen to include vertical tracks 12 and 13, as well as vertical sashes 14. Therebetween is an upper window 16 and a lower window 18 which are slidably secured within said pairs of tracks 12 and 13.

Also shown is a window sill 20 and an upper horizontal sash 22 of the window structure.

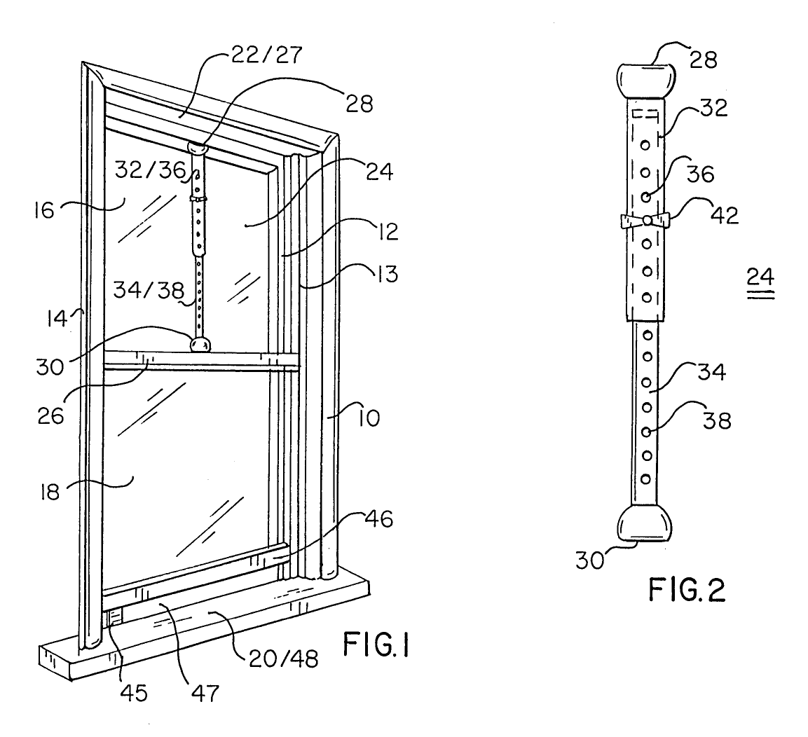

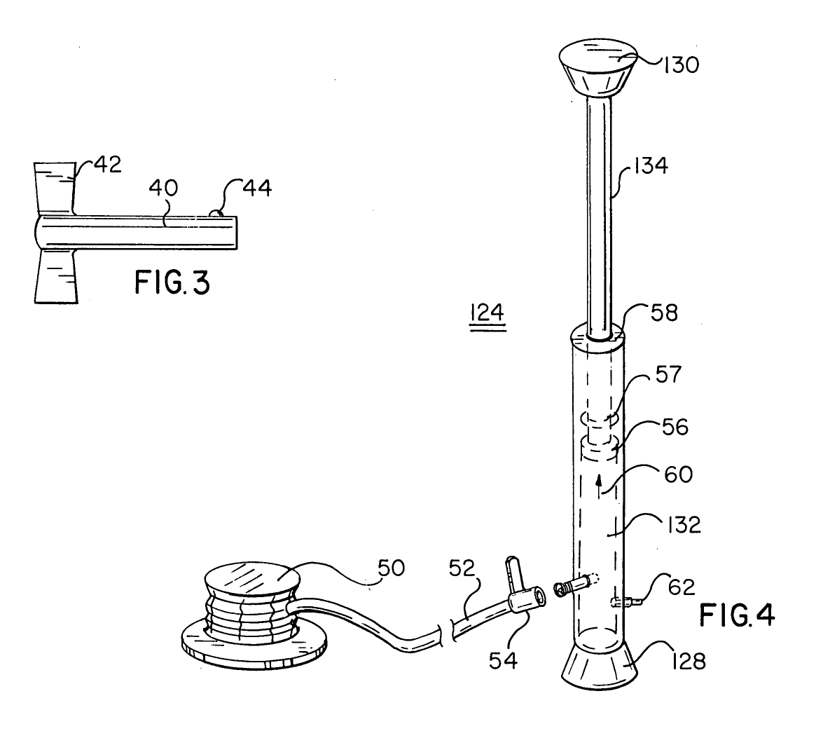

An inventive window security means 24 in accordance with the present invention is shown positioned between an upper rigid edge 26 of lower window 18 and a horizontal portion 27 of said upper window sash 22. The inventive security means 24 more particularly includes elastomeric or resilient upper and lower feet 28 and 30 respectively which are secured at opposing ends of respective elongated hollow tube or cylinder means 32 and piston means 34 in which said piston means can be telescopically adjusted to different positions within said cylinder means 32. This can be achieved through the use of a plurality of cylinder apertures 36 and piston apertures 38, such that a rigid relationship between cylinder means and piston means can be accomplished through the insertion of a peg 40 within an aligned set of said apertures 36 and 38, this as is shown in FIG. 2. As shown in FIG. 3, peg 40 can be provided with a detent 44 to assure that peg 40 can not easily be pulled out of place by a child or animal. For ease of handling, peg 40 can also be provided with a handle 42.

The result of the above structure is a means by which the degree of opening of window 18, and its lower edge 46, relative to a horizontal surface 48 of window sill 20 may be controlled to an extent dictated by the degree of linear extension of the telescoping structure described with reference to FIG. 2. Such a structure is of value in the assurance that windows 16/18 cannot be forcibly opened from the interior or exterior without triggering an alarm which would be responsive to any breakage of the glass of the windows or excessive vibration. Thereby one may, for example, wish to open lower window 18 a distance 47 of 1 to 4 inches to allow for ventilation, thereby not allowing an opening of the window sufficient to present a security problem, either with respect to an unauthorized entrant from the outside or a child or pet from the inside of the house. A support means, such as a block 45, or one of a set thereof of differing sizes, can be positioned within a desired distance or opening 47 of window 18.

The hollow tube or cylinder and the piston means described above can be made of metal, plastic, wood or other suitable materials. The hollow tube and the piston means are preferably cylindrical. However, oval, square shape, or other suitable shapes in the cross section can also be utilized for the purpose of the present invention.

It is to be appreciated that various other means can be employed to affect a range of adjustment between the telescoping portions of the security means 24. One such alternative arrangement is shown in the perspective view of FIG. 4. Therein a pneumatic pump 50 which, in the illustrated embodiment, is operated simply by repetitive pressure from the foot of the user, will convey pressurized air 60 through a channel 52, through an air inlet, such as a one-way valve 54 and, in turn, into a cylinder portion 132 to thereby urge fluid tight sealing means, such as annular grommets 56/57 upward. Secured therewith and within an aperture 58 of hollow tube or cylinder 132 is piston means 134 which, resultant of pressurization of air 60, will force the entire piston rod 134, and its associated resilient foot 130, upward until pumping against feet pump 50 is terminated. When one wishes to reduce the height of piston means 134, a pressure release valve 62 is depressed. Other types of air outlets with suitable air releasing mechanisms can also be used. Further shown in FIG. 4 is resilient foot 128 which is associated with cylinder 132.

In this embodiment, a more precise length of the window security means 124 can be accomplished. The embodiment illustrated in FIG. 4 also obviates the possibility that the combination of peg 40 and handle 42 which is necessary to the embodiments illustrated in FIGS. 1 and 2 may cause scratching or damage to window 16. It is of course to be appreciated that hose 52 of the embodiment illustrated in FIG. 4 can be of any length necessary to render operation thereof convenient. As well, other means, apart from manual means, of operation of pump 50 will be obvious to those of ordinary skill in the art, such means including battery, as well non-battery, operated pneumatic pumps.

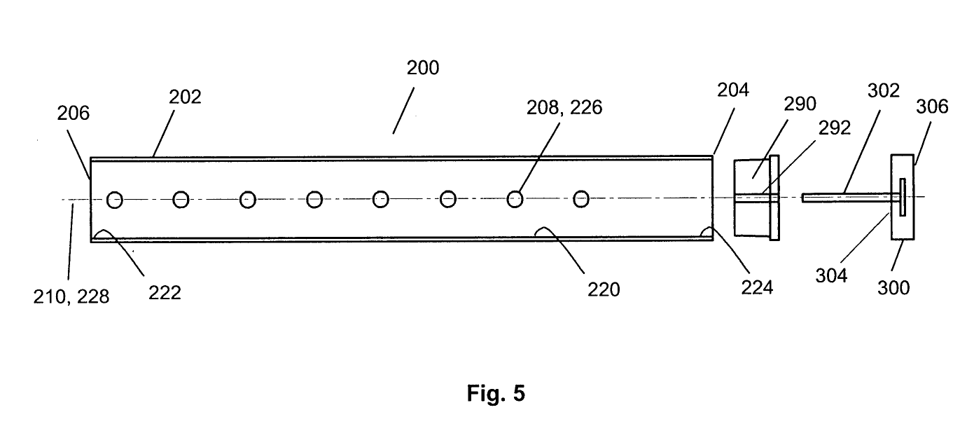

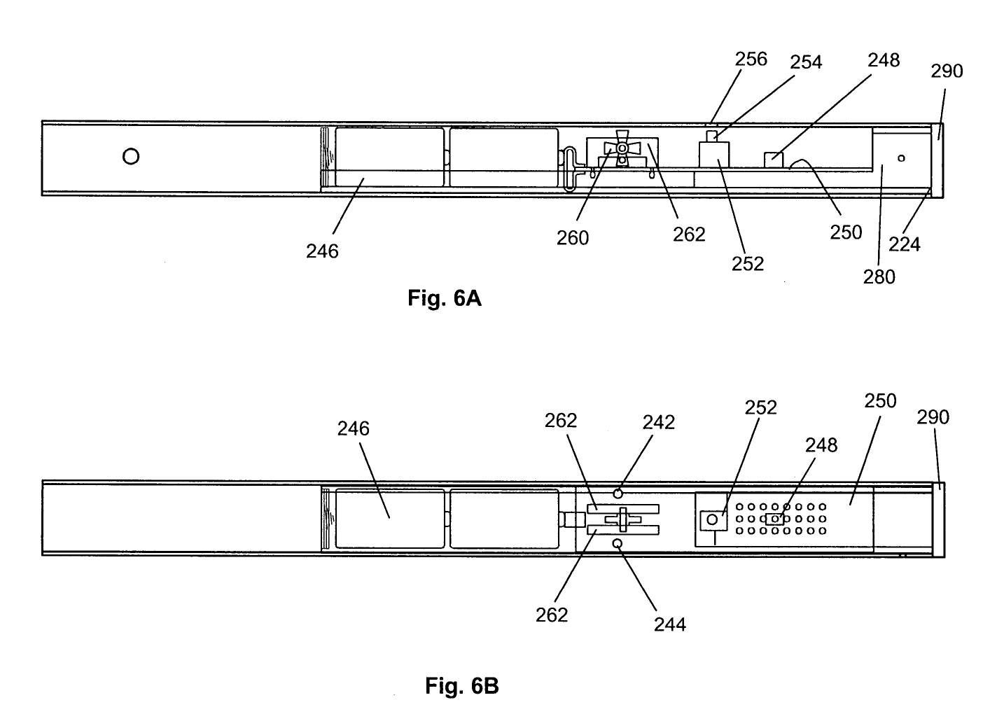

In a preferred embodiment, the present invention provides a dual function window security means 200 for a double hung casement window. As shown in FIGS. 5 and 6, the a dual function window security means comprises an elongated hollow tube 202 having a first end 204 and an opposite second end 206, and spaced apart tube apertures 208 along a longitudinal axis 210 of the elongated hollow tube 202; a hollow piston means 220 having a first end 222 and an opposite second end 224, and spaced apart piston apertures 226 along a longitudinal axis of the piston means 228, the first end of the piston means being telescopically connected to the elongated hollow tube 202; a locking mechanism (not shown) to interlock through the apertures the elongated hollow tube 202 and the hollow piston means 220 along the longitudinal axes 210 and 228; and an orientation sensor 240 positioned inside the hollow piston means 220 near the second end 224, wherein the orientation sensor 240 activates and generates an alarming signal when the dual function window security means 200 is tilted a sufficient amount from a predetermined orientation.

The orientation sensor comprises a photo diode 242, a light receptor 244, an orientation sensitive blocking mechanism 260 positioned between the photo diode 242 and the light receptor 244, a power supply 246, a buzzer 248 and a reset switch 252, connected on a circuitry board 250.

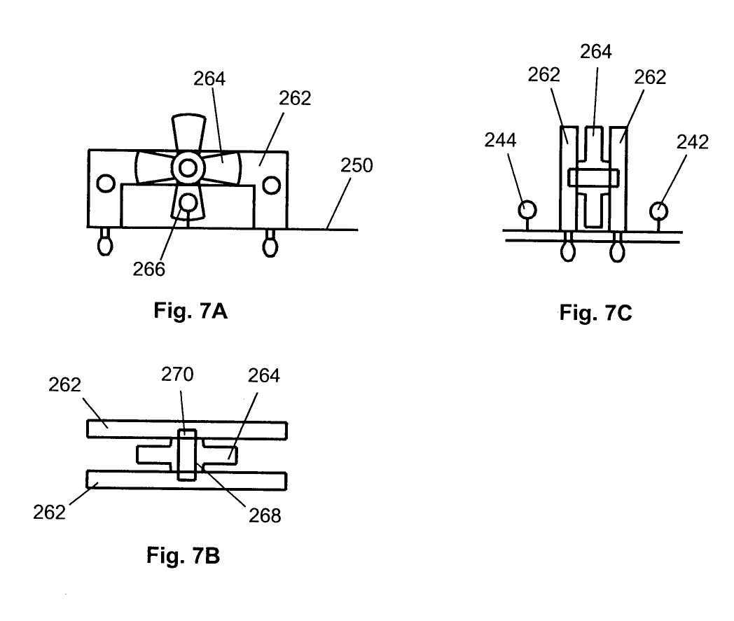

As shown in FIGS. 7A to 7C, the orientation sensitive blocking mechanism 260 comprises a pair of rotor supports 262 mounted on the circuitry board 250, a four bladed vane 264 having one weighted blade 266 and a central bore 268. The bladed vane 264 is positioned between the rotor supports 262 and supported by the rotor supports through a rotor axis 270 inserted through the central bore 268 of the bladed vane 264. When the dual function window security means 200 is either in a vertical or a horizontal position, the blades of the bladed vane 264 will block the light receptor 244 from receiving a light signal from the photo diode 242. When the dual function window security means 200 tilts, the bladed vane 264 swings around the rotor axis 270, which enables the light receptor 244 to receive a light signal from the photo diode 242. This will closes the circuitry and activates the buzzer 248 to generate alarming signals. The sensitivity of the orientation sensor can be adjusted by changing the width of the blades. For example, the orientation sensor can be set to alarm if the dual function window security means 200 experience a five or a ten degree move from a vertical or a horizontal position.

In one embodiment, the reset switch 252 is a reset button 254. The hollow piston means 220 and the elongated hollow tube 202 have a pair of reset holes 256 aligned with the reset button 254, so that the reset button can be reached through the reset holes 256. The dual function window security means 200 can further comprise a removable reset key 258 which can press on the reset button 254 through the reset holes 256 to reset the orientation sensor.

Optionally, the photo diode 242 can be positioned next to one of the spaced apertures 226 of the hollow piston means, which in turn is aligned with one of the spaced apertures 208 of the elongated hollow tube 202. This enables a user to view the light signal emitted from the photo diode 242 through aligned apertures, and to confirm a functioning status of the orientation sensor 240.

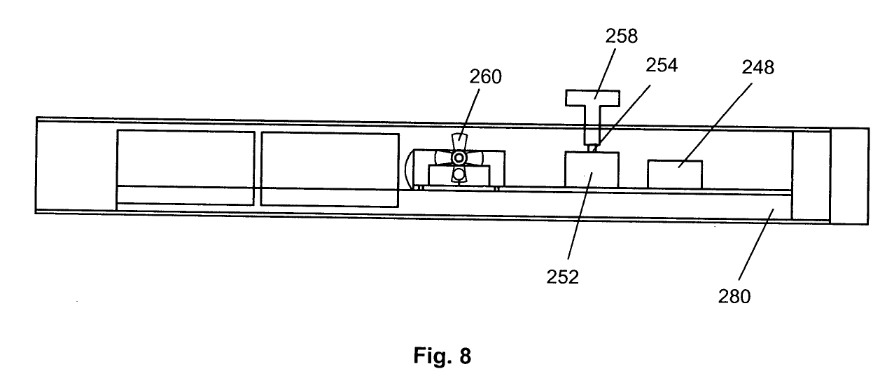

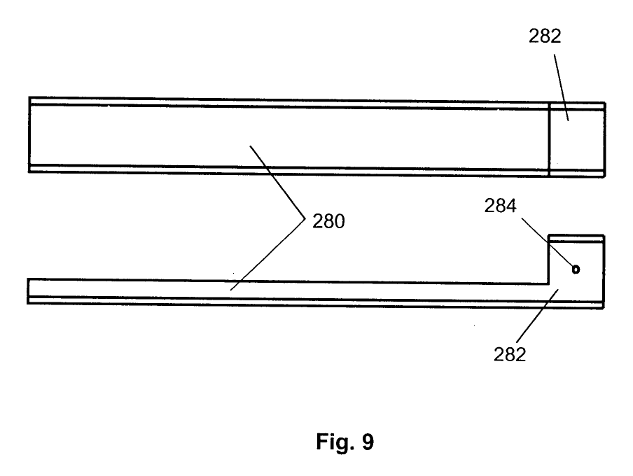

Furthermore, the dual function window security means 200 can further comprise an internal mounting bed 280, which is aligned inside the hollow piston means 220 for mounting the orientation sensor, as shown in FIG. 6A, FIG. 8 and FIG. 9. The internal mounting bed 280 holds batteries, and supports the circuitry board 250. In one embodiment, the internal mounting bed 280 is made of a partially cut PCV pipe. As shown in FIG. 9, one end of the internal mounting bed 280 can be remained as a circular section 282, which is aligned to the second end 224 of the hollow piston means 220. There is a threaded alignment hole 284. Using a screw complementary to the threaded alignment hole 284, the internal mounting bed 280 can be fixed with the hollow piston means in a position which enables alignment of the reset button 254 with the reset holes 256.

In a preferred embodiment, the locking mechanism is a push button, which releases into a pair of aligned apertures to lock the window security means to a desired length. Furthermore, the dual function window security means further includes a length fine tune mechanism. As shown in FIG. 5, the second end 224 of the hollow piston means 220 is a closed by a solid plug 290. The solid plug 290 has a central threaded bore 292, which engages with an end cap 300. The end cap 300 has a threaded rod 302 extending on an internal side 304 of the end cap 300, and it is removably screwed inside the central threaded bore 292 of the solid plug 290. The length of the dual function window security means 200 can be fine tuned by screwing in and out of the end cap 300. Preferably, the external side 360 of the end cap 300 is covered by a resilient material. The solid plug 290 and the end cap 300 can also be installed to the first end 222 of the hollow piston means 220, thereby both ends of the dual function window security means 200 can be used to adjusted the length.

It should be understood that other types of orientation sensors can also be used with the window security means of the present invention. Moreover, other methods of incorporation of the orientation sensor into the window security means can also be utilized. For example, when the above-described air pressure cylinder is used to control the length of the window security means, the orientation sensor can be installed in an extension of the cylinder, which is separated from the cylinder portion.

The dual function window security means of the present invention combines two functionalities into one device. The dual function window security means can lock a double hung casement window, vertically opened or horizontally opened, at a desired level of opening; and can also function as a window alarm. For a vertically opened double hung casement window, one simply positions the lower window panel to a desired height, places the dual function window security means between the upper edge of the lower window panel and the upper window sash, and adjusts the length of the window security means to the equal distance between the upper edge of the lower window panel and the upper window sash. If a burglar tries to open the window by force, he has to remove the dual function window security means first. Such a movement will triggers the orientation sensor, and the buzzer generates alarm signals, as described above, to warn the house owner. Once the buzzer is activated, the owner can deactivate it by pressing the reset button using a reset key.

It is apparent from the above description that the device of the present invention is a simple, inexpensive, and practical tool for securing windows, without using an expensive alarm system. Users can conveniently set each individual window to a desired position, and secure it using the device of the present invention.

It is to be further appreciated that the present embodiments of the inventive window security means do not require any modification of the internal structure of the window sash nor, as is the case in the above-referenced U.S. Pat. No. 4,152,018 to Cantrell, is it necessary to effect any permanent attachment of the piston or cylinder means of the invention to any of the part of the window structure. Therefore, unlike Cantrell, it is not necessary for the use of the invention that the window remain shut at all times. Rather, quite to the contrary, through the present invention, a window can, if desired, be opened to the extent of several inches to thereby afford suitable ventilation without creating any security risk from the outside of the building or safety risk to children or pets inside of the structure.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth herewith.

I claim:

1. A window security means for a double hung casement window comprising:
(a) an elongated hollow tube having a first end and an opposite second end, and spaced apart tube apertures along a longitudinal axis of said elongated hollow tube,
(b) a piston means having a first end and an opposite second closed end having a central threaded bore, and spaced apart piston apertures along a longitudinal axis of said piston means, said first end of said piston means being telescopically connected to said elongated hollow tube,
(c) an end cap having a threaded rod extended on an internal side of said end cap, said end cap is removably screwed inside said central threaded bore of said piston means, and
(d) a locking mechanism to interlock said elongated hollow tube and said piston means through said apertures.

2. The window security means of claim 1 further comprising a pair of resilient feet, one of said feet being connected to said first end of said elongated hollow tube, and another of said feet being connected to an external side of said end cap.

3. The window security means of claim 1, wherein a length of said window security means can be adjusted by telescopically moving said piston means along said longitudinal axis of said elongated hollow tube and interlocking said piston means and said elongated hollow tube with said locking mechanism.

4. The window security means of claim 3, wherein said length of said window security means can be further adjusted by screwing in or out of said end cap inside said central threaded bore of said piston means.

5. A dual function window security means for a double hung casement window comprising:
(a) an elongated hollow tube having a first end and an opposite second end, and spaced apart tube apertures along a longitudinal axis of said elongated hollow tube,
(b) a hollow piston means having a first end and an opposite second end, and spaced apart piston apertures along a longitudinal axis of said piston means, said first end of said piston means being telescopically connected to said elongated hollow tube,
(c) a locking mechanism to interlock through said apertures said elongated hollow tube and said piston means along said longitudinal axes, and
(d) an orientation sensor positioned inside said hollow piston means near said second end, wherein said orientation sensor activates and generates an alarming signal when said dual function window security means is tilted a sufficient amount from a predetermined orientation.

6. The dual function window security means of claim 5, wherein said second end of said piston means is a closed end having a central threaded bore, and said window security means further comprises an end cap having a threaded rod extended on an internal side of said end cap, said end cap is removably screwed inside said central threaded bore of said hollow piston means.

7. The dual function window security means of claim 6 further comprising an internal mounting bed aligned inside said hollow piston means for mounting said orientation sensor.

8. The dual function window security means of claim 7, wherein said orientation sensor comprises a photo diode, a light receptor, an orientation sensitive blocking mechanism positioned between said photo diode and said light receptor, a power supply, a buzzer and a reset switch, connected on a circuitry board.

9. The dual function window security means of claim 8, wherein said orientation sensitive blocking mechanism comprises a pair of rotor supports mounted on said circuitry board, a bladed vane having one weighted blade and a central bore, said bladed vane being positioned between said rotor support and supported by said rotor supports through a rotor axis inserted through said central bore of said bladed vane,
wherein said bladed vane rotates around said rotor axis when said dual function window security means tilts, which enables said light receptor to receive a light signal from said photo diode and activates said buzzer.

10. The dual function window security means of claim 9, wherein said photo diode is positioned next to one of said spaced apertures of said hollow piston means, which enables user to view said light signal emitted from said photo diode through aligned apertures of said hollow piston means and said elongated hollow tube, and to confirm a functioning status of said orientation sensor.

11. The dual function window security means of claim 9, wherein said reset switch is a reset button, said hollow piston means and said elongated hollow tube have a pair of holes aligned with said reset button, and wherein said reset button can be reached through said holes.

12. The dual function window security means of claim 11 further comprising a removable reset key which can press on said reset button through said holes to reset said orientation sensor.

13. The dual function window security means of claim 12 further comprising an alignment means to secure said internal mounting bed in a position which enables alignment of said reset button with said holes.

14. The dual function window security means of claim 13, wherein said predetermined orientation is one selected from the group consisting of an orientation with said longitudinal axes of said elongated hollow tube and said piston means in vertical position, and an orientation with said longitudinal axes of said elongated hollow tube and said piston means in horizontal position.

15. A window security means for a double hung casement window comprising:
(a) a cylinder having an open end and an opposite close end, and an air inlet and an air outlet along a side of said cylinder,
(b) a piston means having a first end and an opposite second end, and a sealing means around said piston means near said first end; said first end of said piston means being telescopically connected to said cylinder through said open end, wherein said sealing means provides a fluid tight connection between said cylinder and said piston means, and
(c) a pair of resilient feet, one of said feet being connected to said close end of said cylinder, and another of said feet being connected to said second end of said piston means.

16. The window security means of claim 15, wherein said sealing means is one selected from the group consisting of o-ring, grommet, and other air sealing means.

17. The window security means of claim 15, wherein said air outlet has an air releasing mechanism, and said air inlet has an air sealing mechanism.

18. The window security means of claim 15 further comprising a pneumatic pump for providing air into said cylinder.

19. The window security means of claim 15, wherein a length of said window security means is adjustable along a longitudinal axis of said cylinder by adjusting air pressure inside said cylinder.

20. A method of securing a double hung casement window comprising the steps of:
(a) positioning one window panel with a desired degree of opening,
(b) placing a window security means between an edge of said window panel at opposing side of said opening and a window sash facing said edge, said window security means comprising an elongated hollow tube, a piston means telescopically connected to said elongated hollow tube, a length adjustment means, and an orientation sensor connected to said window security means, and
(c) adjusting a length of said window security means equivalent to a distance between said edge of said window panel and said window sash, thereby said window security means prevents further opening of said window,
wherein said orientation sensor activates and generates an alarming signal when said dual function window security means is tilted a sufficient amount from a predetermined orientation.
